(19) United States
(12) Patent Application Publication
(10) Pub. No.: US 2011/0215519 A1
(43) Pub. Date: Sep. 8, 2011

(54) SHEET FINISHING APPARATUS AND IMAGE FORMING APPARATUS

(75) Inventor: Yoshiaki SUGIZAKI, Shizuoka-ken (JP)

(73) Assignees: Kabushiki Kaisha Toshiba, Tokyo (JP); Toshiba Tec Kabushiki Kaisha, Tokyo (JP)

(21) Appl. No.: 13/041,336

(22) Filed: Mar. 4, 2011

Related U.S. Application Data
(60) Provisional application No. 61/311,247, filed on Mar. 5, 2010.

(51) Int. Cl. B65H 31/00; B65H 29/20; H05F 3/00

(52) U.S. Cl. 271/208; 271/314

(57) ABSTRACT

A sheet finishing apparatus includes an outer wall having a discharge port of a sheet, a movable tray that stacks the sheet discharged from the discharge port, moves vertically along the outer surface of the outer wall according to a stack amount of the sheet, and has a stacking surface inclined to cause a position of a trailing edge of a sheet to become lower than a position of a leading edge of the sheet, and a support member that is provided at a position outside the outer surface of the outer wall, contacts the trailing edge of the sheet stacked on the movable tray to hold the sheet, and removes static electricity from the sheet.

### CROSS-REFERENCE TO RELATED APPLICATIONS

This application is based upon and claims the benefit of priority from: U.S. provisional applications 61/311,247 filed on Mar. 5, 2010, the entire contents of which are incorporated herein by reference.

### FIELD

Embodiments described herein relate generally to a sheet finishing apparatus and image forming apparatus.

### BACKGROUND

Hitherto, a sheet finishing apparatus is known which is installed downstream of an image forming apparatus, such as a copying machine, a printer or an MFP (Multi-Function Peripheral), and performs finishing, such as sorting and stapling, on a printed sheet.

This type of sheet finishing apparatus includes a fixed tray and a movable tray as a tray onto which a sheet is discharged and is stacked. When a relatively small number of sheets are discharged, the fixed tray is normally selected. On the other hand, a large number of sheets, for example, 1000 sheets or more sheets are discharged, the movable tray is selected. Besides, also when a sheet bundle is sorted or stapled, the movable tray is selected.

Since the movable tray stacks a large number of sheets, it is constructed to move in a vertical direction according to the number of sheets. When the number of sheets is small, the movable tray receives the sheets at a high position. As the number of sheets becomes large, the movable tray moves down. As a result, a difference between a position where a sheet is discharged from the sheet finishing apparatus and a position of the uppermost surface of sheets stacked on the movable tray is almost constant irrespective of the number of stacked sheets.

The stacking surface of the movable tray is inclined at a specified inclination angle so that the position at a side of a leading edge of a sheet becomes higher than that at a trailing edge. The stacking surface of the movable tray is inclined, so that the stacked sheet does not drop to the outside of the movable tray. The trailing edge of the sheet sliding down along the inclination of the stacking surface contacts the outside wall surface of the sheet finishing apparatus and stops.

When the number of sheets stacked on the movable tray becomes large, the friction between the trailing edges of the sheets and the outer wall surface of the sheet finishing apparatus becomes large by sheets' own weight. Thus, when the movable tray moves vertically, there is a case where a vibration occurs at the trailing edges of the sheets, and an unpleasant sound for a user is generated.

On the other hand, a sheet discharged from the sheet finishing apparatus is charged with static electricity to a certain degree. Thus, when the removal of electricity from the sheet is insufficient, an attraction force due to the static electricity acts between the trailing edge of the discharged sheet and the outer wall surface of the sheet finishing apparatus, and a so-called trailing edge remaining phenomenon occurs. The trailing edge remaining phenomenon is an incomplete sheet stacking phenomenon in which although the leading edge side of the sheet is placed on the movable tray, the trailing edge is raised to the outer wall surface of the sheet finishing apparatus and the sheet is curved upward.

Besides, a repelling force due to the static electricity acts between an already stacked sheet and a newly discharged sheet. Thus, the newly discharged sheet is floated by this repelling force, lateral sliding occurs, and stacking is such that the vertical and horizontal alignment is poor.

Therefore, a sheet finishing apparatus is desired in which even when a large number of sheets are stacked on a movable tray, an abnormal sound is not generated, and removal of electricity from a sheet can be sufficiently performed.

### BRIEF DESCRIPTION OF THE DRAWINGS

In the attached drawings:

FIG. 1 is a perspective view showing an example of an outer appearance of a sheet finishing apparatus and an image forming apparatus of an embodiment;

FIG. 2 is an upper enlarged view of the sheet finishing apparatus;

FIG. 3 is a sectional view showing a structural example of the sheet finishing apparatus;

FIG. 4 is a view for explaining a positional relation between a standby tray and a processing tray;

FIG. 5 is a view showing an example of a detailed structure of the processing tray;

FIG. 6 is a view showing a flow of a sheet when the sheet is discharged to a movable tray via the standby tray;

FIG. 7 is a view showing a flow of a sheet when the sheet is discharged to the movable tray via the processing tray;

FIGS. 8A to 8D are views for explaining an operation of dropping a sheet from the standby tray to the processing tray;

FIGS. 9A and 9B are views for explaining a vertical movement of a shutter;

FIG. 10 is a view for explaining a structural example of the vicinity of an upper part of the shutter;

FIG. 11 is a view showing an example of a drive mechanism of the shutter;

FIG. 12 is a schematic perspective view showing a structural example and an arrangement example of the movable tray and a support member unit;

FIG. 13 is a schematic sectional view showing the structural example and the arrangement example of the movable tray and the support member unit;

FIGS. 14A to 14C are views for explaining a relation between the vertical movement of the movable tray and the shutter and the movement of the support member (electricity removing belt); and

FIG. 15A and FIG. 15B are views for explaining an inclination of an upper part of the support member (electricity removing belt) and a positional relation between an upper roller of the support member and a conveyance roller.

### DETAILED DESCRIPTION

Embodiments of a sheet finishing apparatus and an image forming apparatus will be described with reference to the attached drawings.

According to an embodiment, a sheet finishing apparatus includes an outer wall having a discharge port of a sheet, a movable tray that stacks the sheet discharged from the discharge port, moves vertically along the outer surface of the outer wall according to a stack amount of the sheet, and has a stacking surface inclined to cause a position of a trailing edge of a sheet to become lower than a position of a leading edge of the sheet, and a support member that is provided at a position outside the outer surface of the outer wall, contacts the trailing edge of the sheet stacked on the movable tray to hold the sheet, and removes static electricity from the sheet.

### (1) Structure

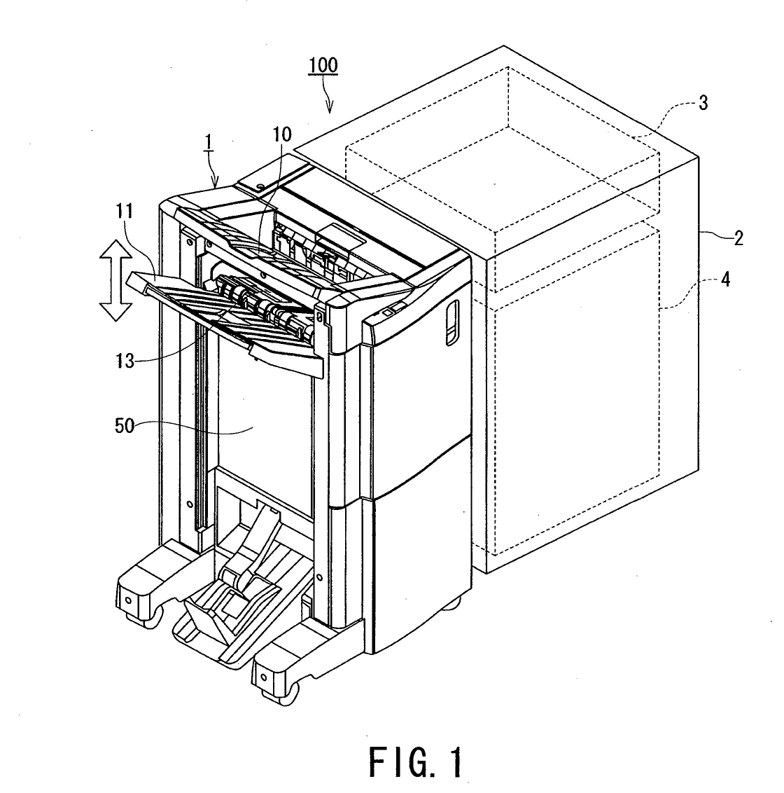

FIG. 1 is an outer appearance perspective view showing a basic structure of an image forming apparatus 100 provided with a sheet finishing apparatus 1 of a first embodiment. The image forming apparatus 100 includes an image forming apparatus body 2 and the sheet finishing apparatus 1 arranged adjacent to the body 2.

The body 2 includes a scanner 3 to read a document, and a printer 4 to print an image read by the scanner 3 on a sheet.

The sheet finishing apparatus 1 includes a fixed tray 10 onto which a sheet printed in the body 2 is discharged and stacked, and a movable tray 11 that moves in the vertical direction as indicated by an arrow and stacks a large number of printed sheets. The sheet finishing apparatus 1 has a function of sorting plural printed sheets (sheet bundle) and a function of stitching sheets with staples.

The movable tray 11 moves in the vertical direction along an outer wall 50 of the sheet finishing apparatus 1 at the discharge side.

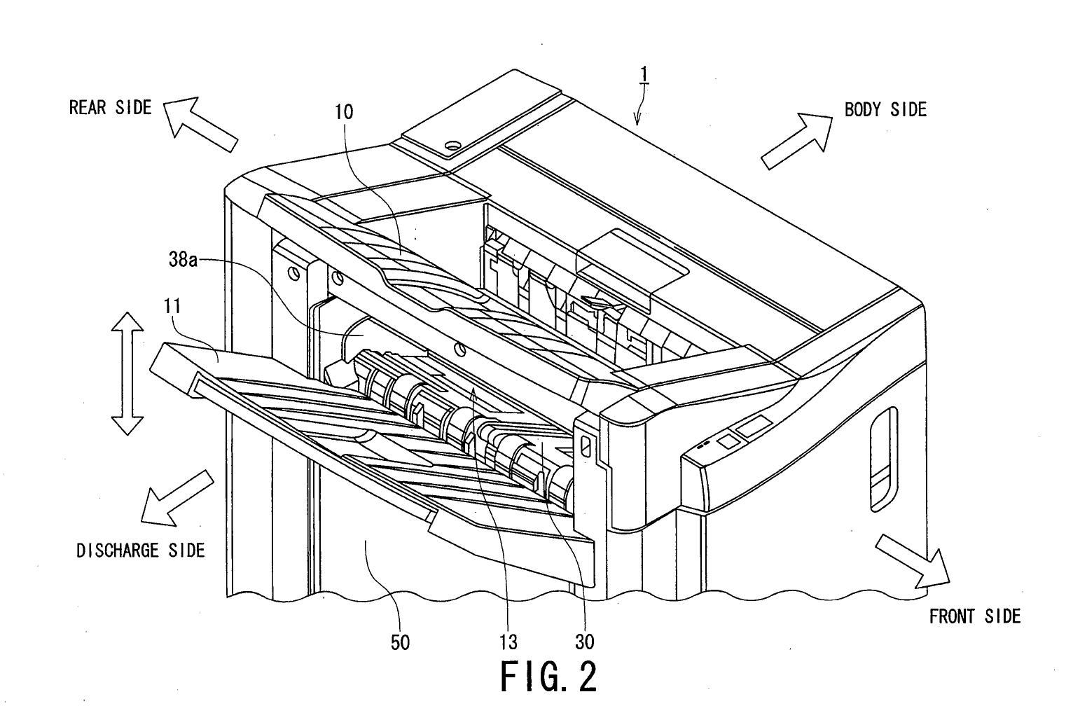

FIG. 2 is a perspective view in which an upper part of the sheet finishing apparatus 1 is enlarged. FIG. 2 is the view seen in the same direction as FIG. 1.

As indicated by outline arrows of FIG. 2, a direction in which a sheet or a sheet bundle is discharged is called a discharge side, a direction in which the body 2 is installed called a body side, a right side when the body side is seen from the discharge side is called a front side, and a left side is called a rear side.

A discharge port 13 is provided between the fixed tray 10 and the movable tray 11, and a sheet or a sheet bundle to be stacked on the movable tray 11 is discharged from the discharge port 13.

A processing tray 30 is provided at the back lower part of the discharge port 13. Lateral alignment plates 38a and 38b are provided at the rear side and the front side of the processing tray 30. In FIG. 2, only the rear side lateral alignment plate 38a is seen.

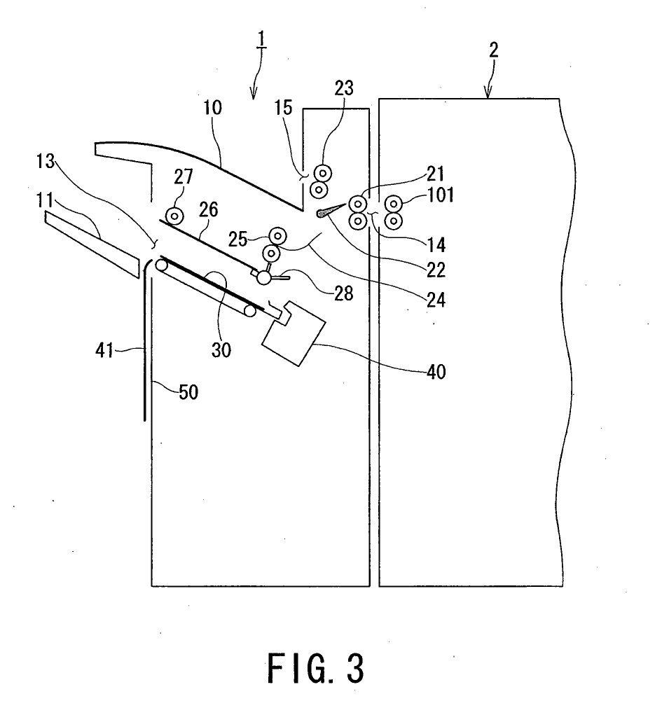

FIG. 3 is a sectional view schematically showing a main inner structure of the sheet finishing apparatus 1 seen from the front side.

An inlet roller 21 is provided at a position opposite to an exit roller 101 of the body 2, and a gate flap 22 is provided downstream thereof. A fixed tray roller 23 is provided above the gate flap 22. A conveyance guide 24 curved downward and a conveyance roller 25 are provided below the gate flap 22, and a standby tray 26 is provided in front of the conveyance roller 25.

As shown in FIG. 3, the standby tray 26 is inclined so that the height of an end at the body side is lower than the height of an end at the discharge side. A buffer roller 27 is provided in the vicinity of the end of the standby tray 26 at the discharge side. On the other hand, a paddle 28 is provided in the vicinity of the standby tray at the body side.

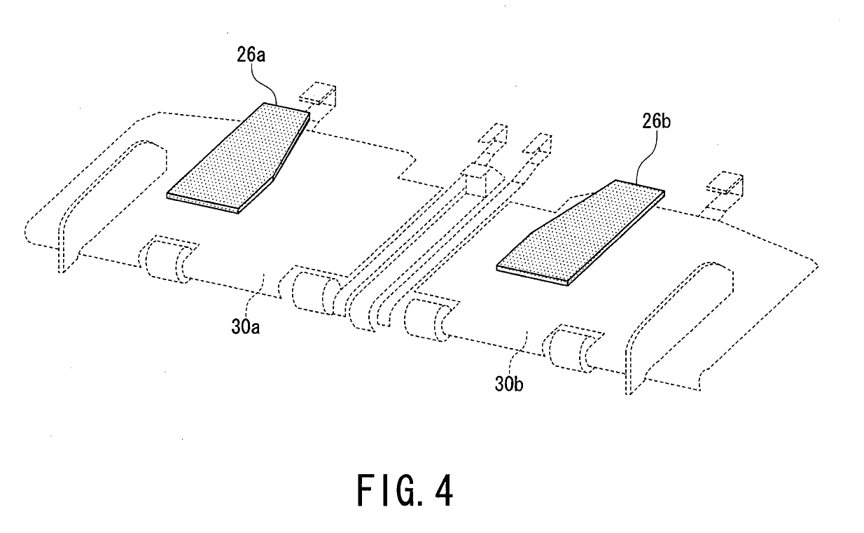

FIG. 4 is a schematic perspective view schematically showing a structure of the standby tray 26. FIG. 4 shows the standby tray 26 indicated by hatching and the processing tray 30 disposed below the standby tray 26 and indicated by broken lines. The standby tray 26 includes a rear side standby tray 26a and a front side standby tray 26b, and can be opened and closed in the front and rear direction as described later by a not-shown drive mechanism.

The processing tray 30 is provided below the standby tray 26. Similarly to the standby tray 26, the processing tray 30 is also inclined so that the height of an end at the body side is lower than the height of an end at the discharge side. A shutter 41 is provided along the outer wall 50 of the sheet finishing apparatus 1 at the discharge side and between the processing tray 30 and the movable tray 11. As shown in FIG. 3, the shutter 41 can move vertically, and as described later, the shutter moves up when a sheet is directly discharged from the standby tray 26 to the movable tray 11, and closes an opening part of the discharge port 13 between the standby tray 26 and the processing tray 30. A stapler 40 is disposed in front of the processing tray 30 at the body side.

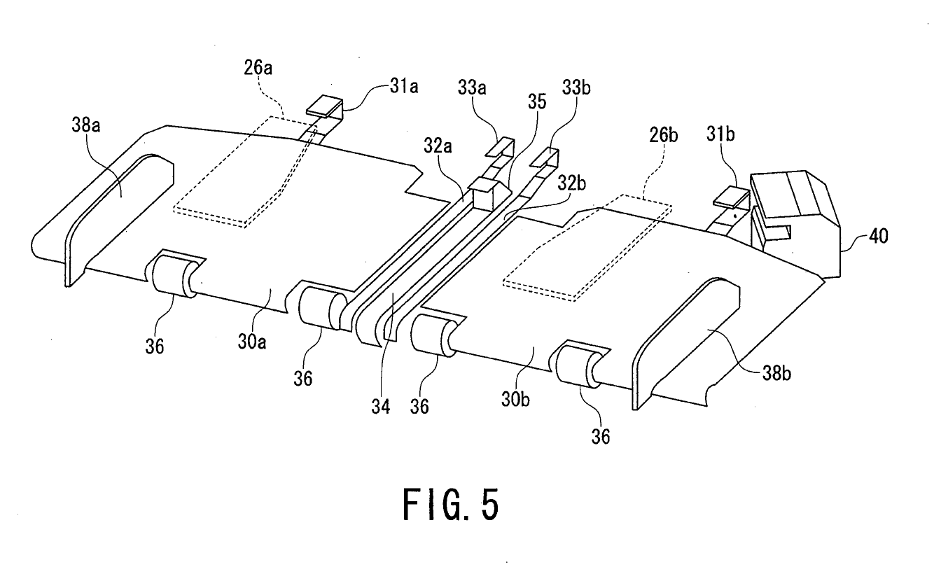

FIG. 5 is a perspective view showing a structure of the processing tray 30 and its surroundings. The processing tray 30 is divided at the center into a rear side and a front side processing trays 30a and 30b. Back stoppers 31a and 31b are respectively provided at ends of the processing trays 30a and 30b at the body side, and four sheet bundle conveyance rollers 36 are provided at ends thereof at the discharge side.

In the divided part of the processing tray 30, a bundle pawl belt 34 and eject belts 32a and 32b at both sides thereof are arranged adjacently.

A bundle pawl 35 is fixed to an outer periphery of the bundle pawl belt 34. The bundle pawl belt 34 continuously rotates so that the bundle pawl 35 is moved from the body side to the discharge side on the front side of the processing tray 30, while the bundle pawl 35 returns from the discharge side to the body side on the back side of the processing tray 30.

On the other hand, ejectors 33a and 33b are respectively fixed to outer peripheries of the eject belts 32a and 32b. The eject belts 32a and 32b are coupled to the same drive source as the bundle pawl belt 34 by an electromagnetic clutch (not shown), and move the ejectors 33a and 33b to the vicinity of the center of the processing tray 30 substantially in synchronization with the movement of the bundle pawl 35. When the ejectors 33a and 33b convey the trailing edge of a sheet to the vicinity of the center of the processing tray 30, the bundle pawl 35 of the bundle pawl belt 34 takes over the conveyance of the sheet, and the bundle pawl 35 pushes out the trailing edge of the sheet to the movable tray 11 side. On the other hand, after the bundle pawl 35 takes over the conveyance of the sheet, the electromagnetic clutch is turned off, and the ejectors 33a and 33b are returned to positions (home positions of the ejectors) shown in FIG. 5 by elastic force of a not-shown spring. As stated above, while the bundle pawl 35 continuously rotates around the processing tray 30, the ejectors 33a and 33b reciprocate on the processing tray 30.

The home positions of the ejectors 33a and 33b and the rear stoppers 31a and 31b are located at almost the same position.

The processing trays 30a and 30b are respectively provided with the lateral alignment plates 38a and 38b. The lateral alignment plates 38a and 38b are structured to be capable of moving in the rear and front direction by a drive mechanism. The one stapler 40 is provided at the body side of the processing tray 30. The stapler 40 staples a sheet bundle printed in the body 2.

A stacking mode of the sheet finishing apparatus 1 is roughly classified into a simple stacking mode and a processing stacking mode.

The simple stacking mode is an operation mode in which printed sheets are simply discharged and stacked as it is. The user can select the fixed tray 10 or the movable tray 11 as a tray for discharging and stacking. When the number of stacked sheets increases, the movable tray 11 gradually moves down, and many sheets (for example, 2000 sheets or more) can be stacked. Thus, when the number of print sheets is large, the user selects the movable tray 11 as the discharge destination.

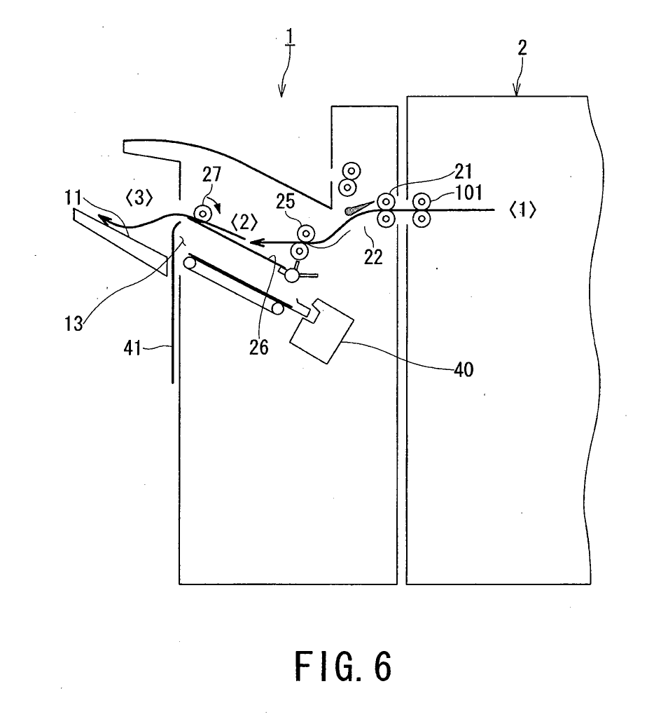

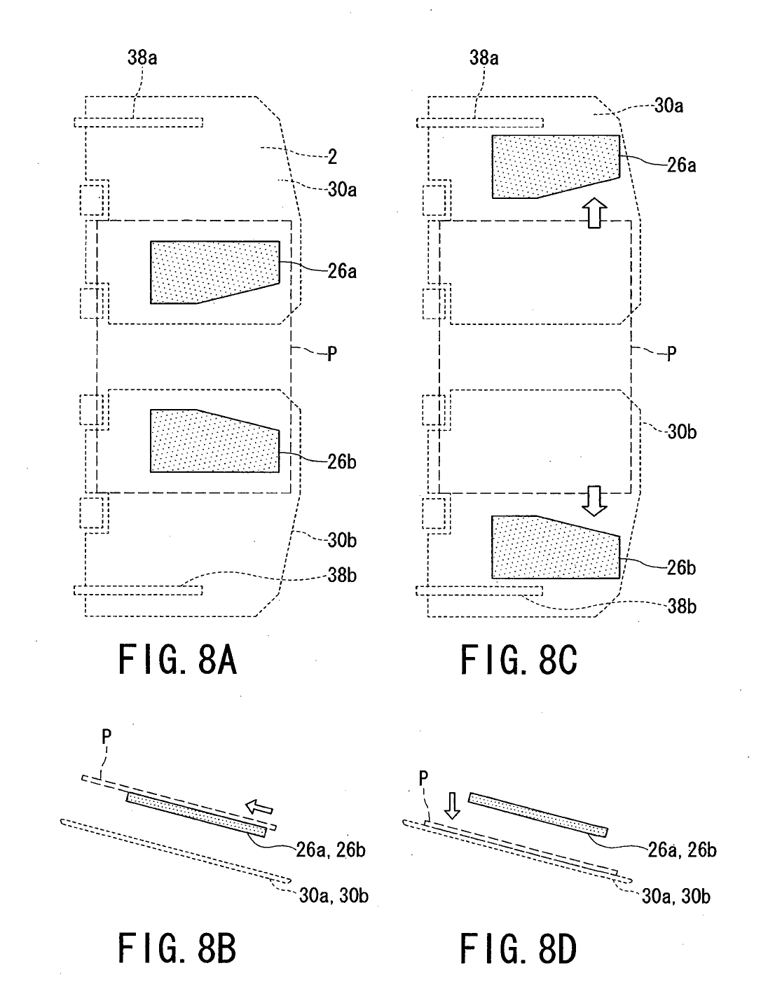

FIG. 6 is a view showing a flow of a sheet in the simple stacking mode when the movable tray 11 is selected as the discharge destination. When the movable tray 11 is selected, as shown in FIG. 6, the gate flap 22 moves to a position inclined downward from the inlet roller 21 to the conveyance roller 25. After the sheet <1> printed in the body 2 is pulled in by the inlet roller 21 of the sheet finishing apparatus 1 from the exit roller 101, the sheet moves downward along the gate flap 22, is temporarily placed on the standby tray 26 and is moved to the buffer roller <2>. At this time, the standby trays 26a and 26b are closed (state of FIG. 8A), and the sheet does not drop to the processing tray 30. Besides, the buffer roller 27 contacts the standby tray 26 and rotates in an arrow direction of FIG. 6. Thus, the sheet placed on the standby tray 26 is pulled out by the buffer roller 27, is discharged onto the movable tray 11, and is sequentially stacked <3>.

In the simple stacking mode when the movable tray 11 is selected, the shutter 41 moves up, and the opening part of the discharge port 13 between the standby tray 26 and the processing tray 30 is closed. The shutter 41 prevents the sheet discharged to the movable tray 11 or the stacked sheet from returning to the processing tray 30 through the discharge port 13.

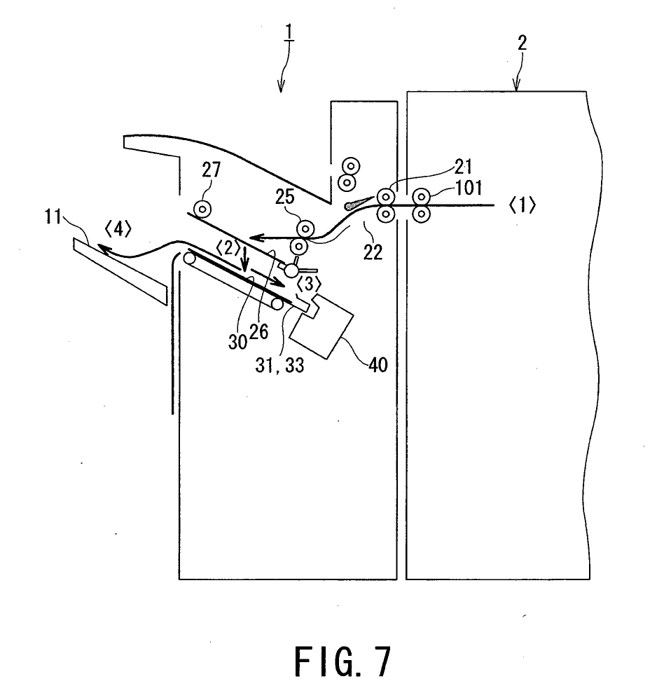

FIG. 7 is a view showing a flow of a sheet in the processing stacking mode. In the processing stacking mode, sorting is performed in which sheets or sheet bundles are discharged while alternately offset to the front side and the rear side and are stacked, or stapling is performed in which the edge of a sheet bundle is stapled at one place or two places. These processings are performed on the processing tray 30.

After a sheet <1> printed in the body 2 is pulled in by the inlet roller 21 of the sheet finishing apparatus 1 from the exit roller 101, the sheet moves downward along the gate flap 22, and is once stacked on the standby tray 26. At this time, the standby trays 26a and 26b are closed as shown in FIG. 8A. An interval between the standby trays 26a and 26b varies according to the sheet size. In any sheet size, the sheet P does not directly drop to the processing tray 30, and is once received by the standby tray 26 (FIG. 8B).

Thereafter, as shown in FIG. 8C, the standby trays 26a and 26b are opened in the front and rear direction, and the sheet P drops to the processing tray 30 (FIG. 8D).

A specified number of sheets are stacked on the processing tray 30, and the trailing edge of the sheet bundle is pressed to the rear stoppers 31a and 31b and the ejectors 33a and 33b, so that longitudinal alignment is performed. Besides, the lateral alignment plates 38a and 38b are pressed to the edges of the sheet bundle at both sides, so that lateral alignment is performed.

Sorting is performed such that after the longitudinal alignment is performed, for each sheet bundle subjected to the processing of the lateral alignment position, the sheet bundle is alternately offset to the front side and the rear side.

On the other hand, stapling is performed using the stapler 40 after the longitudinal alignment and the lateral alignment are ended.

The sheet bundle subjected to the sorting or the stapling is discharged from the processing tray 30, and is sequentially stacked on the movable tray 11. Besides, in the simple stacking mode, when the movable tray 11 is selected, the sheet is discharged from the standby tray 26 and is sequentially stacked on the movable tray 11.

### (2) Detailed Structure of Surroundings of the Movable Tray

Hereinafter, the detailed structure of surroundings of the movable tray 11 will be described.

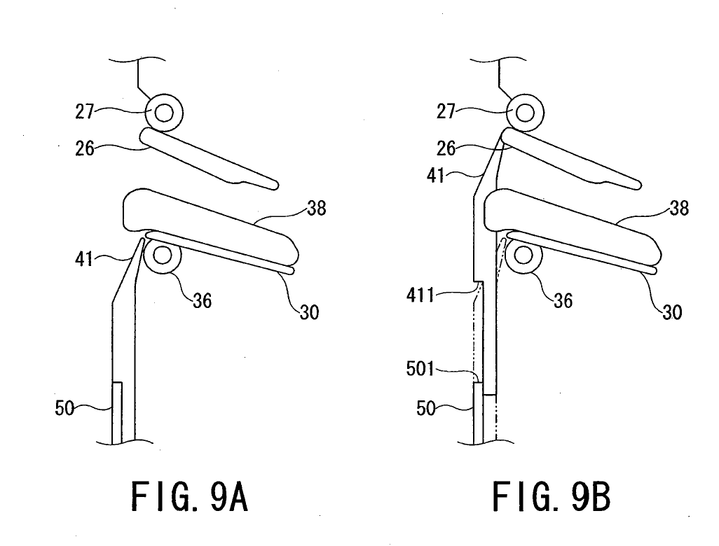

FIG. 9A and FIG. 9B are schematic views for explaining the operation of the shutter 41 in the structure of the surroundings of the movable tray 11. The shutter 41 moves vertically. When sheets are discharged from the processing tray 30 to the movable tray 11, as shown in FIG. 9A, the shutter 41 stands by at a first standby position where the discharge of the sheet is not prevented. On the other hand, when sheets are directly discharged from the standby tray 26 to the movable tray 11, as shown in FIG. 9B, the shutter 41 moves to an upper second standby position from the first standby position. That is, the shutter 41 stands by at the second standby position and prevents the sheet discharged from the standby tray 26 or the sheet on the movable tray 11 from entering the processing tray 30 side. A state where the shutter 41 stands by at the first standby position is called an open state, and a state where the shutter stands by at the second standby position is called a closed state.

As shown in FIG. 9B, the shutter 41 includes a stepped portion 411 on the surface at the movable tray 11 side. The outer wall 50 also has a stepped portion 501. Although the shutter 41 moves up and down along the outer wall 50 of the sheet finishing apparatus 1, when the sheet is discharged from the processing tray 30, the stepped portion 411 of the shutter 41 contacts the stepped portion 501 of the outer wall 50, and the shutter 41 does not move down any more.

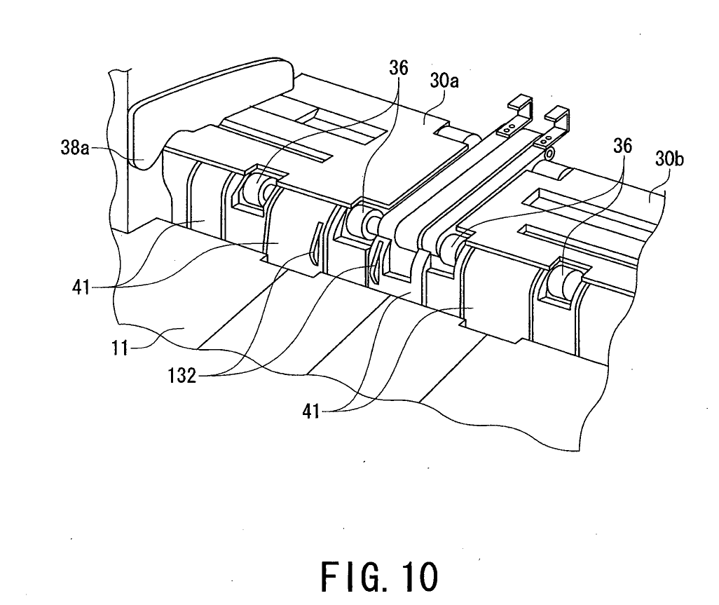

The shutter 41 stands by at a position where the front edge of the shutter 41 is lower than the sheet stacking surface of the processing trays 30a, 30b, as shown in FIG. 10. A detection member 132 for detecting the upper surface of the movable tray 11 or the uppermost surface of sheets stacked on the movable tray 11 is attached to the front edge portion of the shutter 41. The detection member 132 may be, for example, a micro-sensor or a micro-actuator.

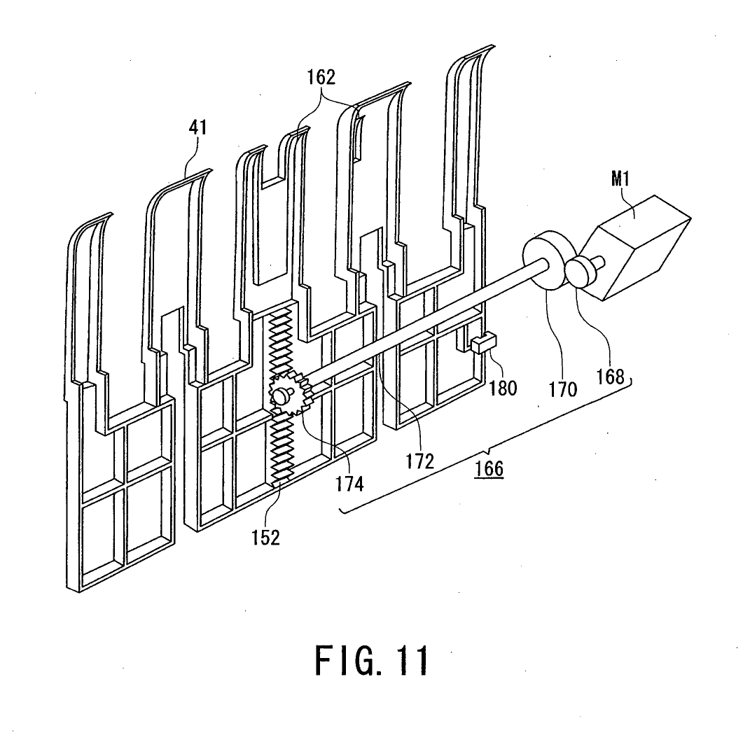

FIG. 11 is a schematic view for explaining a drive mechanism of the shutter 41. Here, a surface of the shutter 41 at the discharge side, that is, at the side where the movable tray 11 is arranged is called a front surface of the shutter 41, and the opposite side is called a back surface. The shutter 41 includes a rack 152 on the back surface of the shutter 41. The shutter 41 moves in the vertical direction by a drive mechanism 166. The drive mechanism 166 includes a motor Ml, gears 168 and 170, a shaft 172, and a gear 174 engaged with the rack 152. When the power of the motor M1 is transmitted to the gear 174 through the gears 168 and 170 and the shaft 172, the shutter 41 moves in the vertical direction. The motor M1 may be, for example, a stepping motor.

A detection member 180 detects a position of the shutter 41 in the vertical direction. The detection member 180 may be, for example, a micro-sensor or a micro-actuator. In this embodiment, the detection member 180 detects the close state (hereinafter referred to as home position HP) of the shutter 41. The position of the shutter 41 is controlled by the number of pulses given to the motor M1 with respect to the HP. Incidentally, the detection member 180 may detect the open state of the shutter 41. The detection member 132 shown in FIG. 10 is arranged in a hole 162 of the front edge portion of the shutter 41.

The sheet finishing apparatus 1 of this embodiment includes a support member 196 to support the trailing edge of a sheet stacked on the movable tray 11. The support member 196 is formed of, for example, a belt.

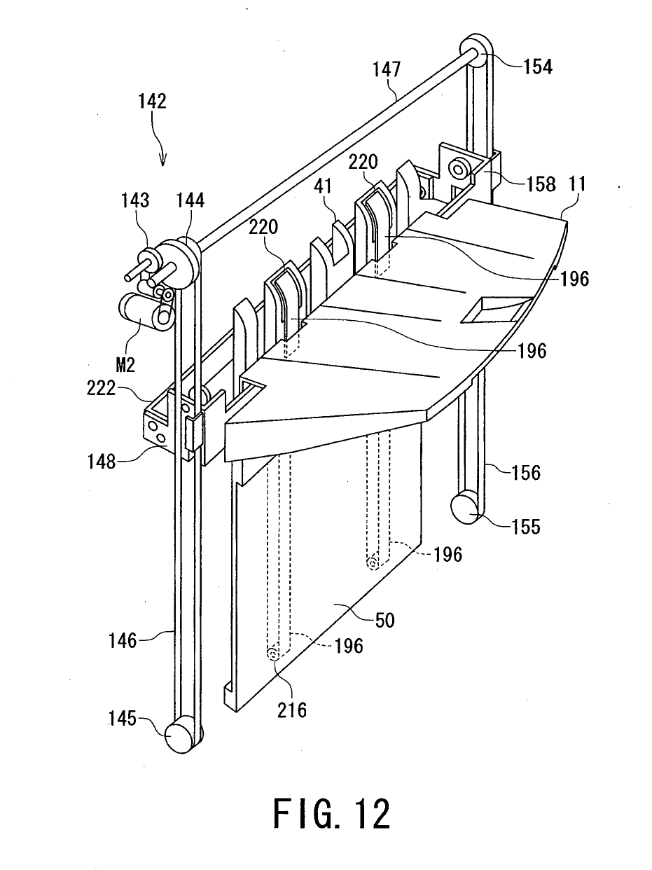

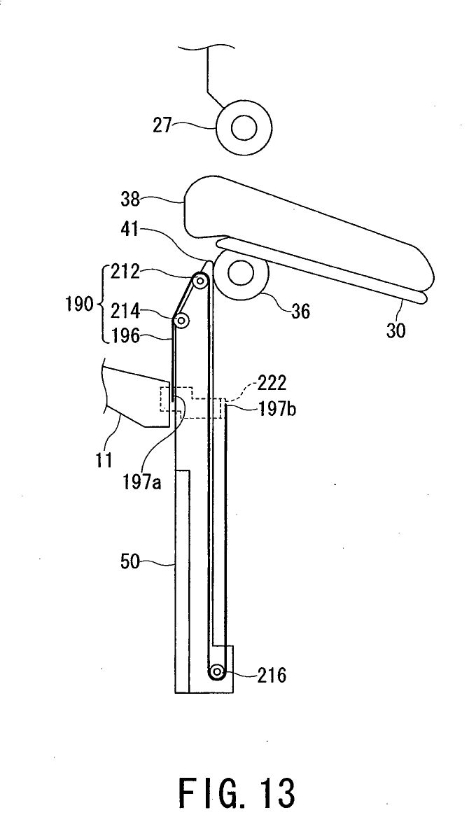

FIG. 12 is a schematic perspective view showing a structural example and an arrangement example of a support member unit 190 including the support member 196 and a drive mechanism of the movable tray 11 in the embodiment, and FIG. 13 is a schematic sectional view.

The movable tray 11 moves in the vertical direction by a drive mechanism 142. The movable tray 11 moves along the outer surface of the shutter 41 in an upper part of a movement range, and moves along the outer surface of the outer wall 50 in a lower part of the movement range.

As shown in FIG. 12, the drive mechanism 142 includes a motor M2, a gear 143, pulleys 144, 145, 154 and 155, belts 146 and 156, and shafts 147 and 157. The motor M2 may be, for example, a DC motor. The belt 146 is wound around the pulleys 144 and 145. Besides, the belt 156 is wound around the pulleys 154 and 155. The pulleys 144 and 154 are attached to the shaft 147. The pulleys 145 and 155 are attached to a not-shown shaft. The power of the motor M2 is transmitted to the shaft 147 through the gear 143. The movable tray 11 is attached to the belts 146 and 156 by attachment members 148 and 158. Accordingly, when the motor M2 is driven, the movable tray 11 moves up or down.

A lateral frame member (fixing member) 222 is attached to the attachment members 148 and 158 of the movable tray 11. When the motor M2 is driven, the lateral frame member 222, together with the movable tray 11, moves up or down.

Besides, the support member unit 190 of the embodiment includes rotation members 212, 214 and 216 and the support member (belt) 196 (See also FIG. 13). The rotation members 212, 214 and 216 may be, for example, rollers or pulleys. The rollers 212 and 214 are attached to an upper part of the shutter 41. On the other hand, the roller 216 is attached to a lower part of the shutter 41.

The rollers 212 and 214 are attached to holes 220 of the upper part of the shutter 41. Incidentally, instead of the holes 220, notches may be provided at the upper part of the shutter 41. The support member 196 is wound around the rollers 212, 214 and 216. As shown in FIG. 13, one end 197a of the support member 196 is fixed to the vicinity of the stacking surface of the movable tray 11 at the outer wall 50 side. Besides, the other end 197b of the support member 196 is fixed to the lateral frame member 222. The other end 197b of the support member 196 is fixed to the lateral frame member 22 at a position of the side (that is, the back side of the shutter 41) opposite to the side of the shutter 41 facing the movable tray 11.

The support member 196 extended from the roller 212 to the movable tray 11 is located at the position outside the outer surface of the shutter 41 or the outer surface of the outer wall 50. Accordingly, the trailing edge of the sheet stacked on the movable tray 11 directly contacts the support member 196. Besides, the support member 196 is wound to be inclined along the surface of the shutter 41 between the roller 212 and the roller 214.

The support member 196 moves in the same direction and at the same speed as the movable tray 11, and contacts the trailing edge of the sheet stacked on the movable tray 11 to receive the sheet.

It should be noted that the support member 196 also removes static electricity from the sheet. The support member 196 is, for example, an electricity removing belt.

The surface of the electricity removing belt, which contacts the sheet, has electrical conductivity, and the surface having the conductivity is electrically grounded.

For example, the surface of the electricity removing belt, which contacts the sheet, is formed of a conductive plastic film, or the surface which contacts the sheet is covered with a conductive plastic film. The conductive plastic film is electrically grounded.

As another example, the surface of the electricity removing belt, which contacts the sheet, is formed of a conductive nonwoven fabric, or the surface which contacts the sheet is covered with a conductive nonwoven fabric. The conductive nonwoven fabric is electrically grounded. The conductive nonwoven fabric is formed of, for example, Thunderon (registered trademark).

The material of the electricity removing belt is not limited to the above, and a newly developed material having conductivity and flexibility may be used.

The belt having a conductive part on the surface may be such that a conductive material such as a conductive plastic film or a conductive nonwoven fabric, or a newly developed material having conductivity and flexibility is bonded to a material, such as rubber, having flexibility, or such material is coated.

The electricity removing belt is electrically connected to a housing metal part of the sheet finishing apparatus 1 and a housing metal part of the image forming apparatus body 2, and the portion of the electricity removing belt having the conductivity is electrically grounded. For example, a part of the portion of the electricity removing belt having the conductivity and a part of the housing metal part of the sheet finishing apparatus 1 are always slidably brought into contact with each other, so that the electrical grounding is realized.

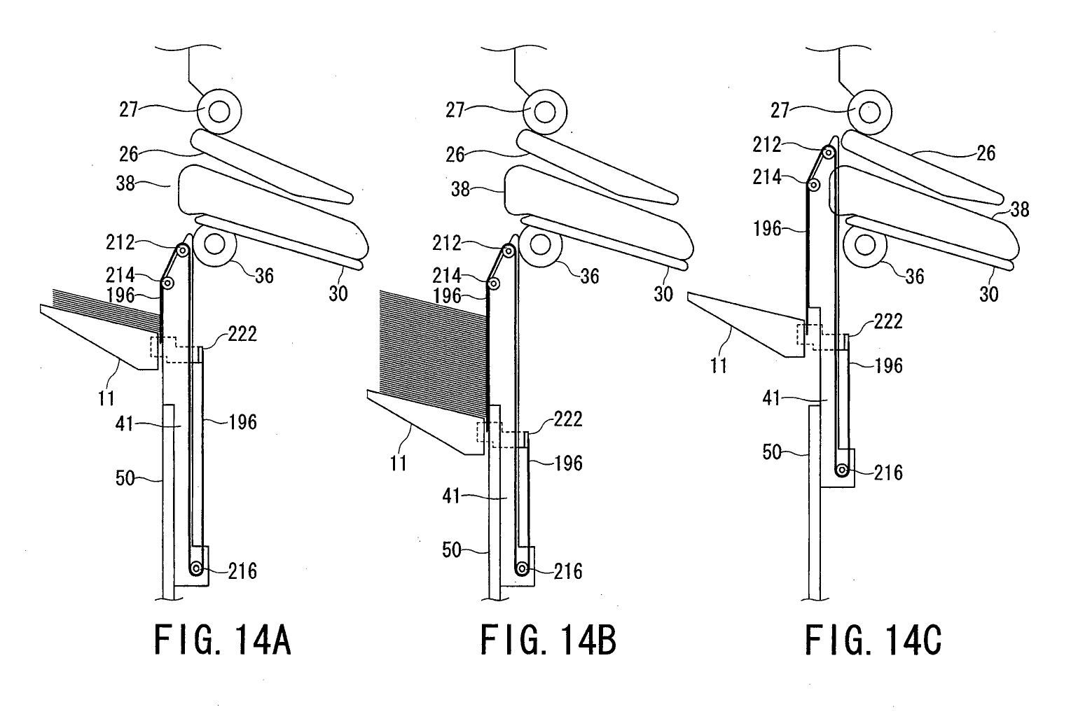

FIGS. 14A to 14C are views for explaining the operation of the support member unit 190 at the time of discharge of sheets. When a sheet is discharged via the processing tray 30, as shown in FIG. 14A, the shutter 41 stands by at the first standby position where the discharge of the sheet is not prevented (open state). The sheet discharged to the movable tray 11 moves to the shutter 41 side by the inclination of the stacking surface of the movable tray 11. The trailing edge of the moved sheet contacts the support member 196.

As shown in FIG. 14B, the movable tray 11 moves down as the sheets are stacked. The trailing edge of the sheet on the movable tray 11 is supported by the support member 196. In this embodiment, as described above, both the ends of the support member 196 are fixed to the movable tray 11 and the lateral frame member 222, and the support member is wound around the rollers 212, 214 and 216. Accordingly, the support member 196 travels in synchronization with the movement of the movable tray 11. That is, when the movable tray 11 moves down, the support member 196 is pulled out from the hole 220 of the shutter 41, and the length of the support member 196 extended from the roller 212 to the movable tray 11 becomes long. At this time, the length of the support member 196 extended from the lower roller 216 to the lateral frame member 222 becomes short.

On the other hand, when the movable tray 11 moves up, the support member 196 is pulled into the hole 220 of the shutter 41. As shown in FIG. 14A, the length of the support member 196 extended from the roller 212 to the movable tray 11 becomes short, and the length of the support member 196 extended from the lower roller 216 to the lateral frame member 222 becomes long.

As stated above, according to this embodiment, the movement of the support member 196 is synchronized with the movement of the movable tray 11, and the support member 196 moves in the same direction and at the same speed as the movable tray 11. Besides, since the support member 196 travels in the vertical direction by the movement of the movable tray 11, it is not necessary to use a special drive mechanism to move the support member 196.

When the buffer roller 27 directly discharges a sheet from the standby tray 26 to the movable tray 11, as shown in FIG. 14C, the shutter 41 moves from the first standby position to the upper second standby position (close state). The shutter 41 standing by at the second standby position prevents the sheet discharged from the standby tray 26 or the sheet on the movable tray 11 from entering the processing tray 30 side. As described above, both the ends of the support member 196 are fixed to the movable tray 11 and the lateral frame member 222, and the support member is wound by the rollers 212, 214 and 216. Accordingly, when only the shutter 41 moves up while the movable tray 11 is stopped, the length of the support member between the roller 216 and the lateral frame member 222 becomes short, and the length of the support member 196 extended from the roller 212 to the movable tray 11 becomes long. At this time, the support member 196 is pulled out from the hole 220 of the shutter 41. On the other hand, when only the shutter 41 moves down while the movable tray 11 is stopped, the length of the support member 196 between the roller 216 and the lateral frame member 222 becomes long, and the length of the support member 196 extended from the roller 212 to the movable tray 11 becomes short. At this time, the support member 196 is pulled into the hole 220 of the shutter 41. As stated above, since the upper position of the support member 196 (i.e., the position of the roller 212) moves together with the position of the upper part of the shutter 41, even when the shutter 41 is in the close state or in the open state, the support member 196 is strained at all times from the upper part of the shutter 41 to the movable tray 11. Thus, the trailing edge of the sheet on the movable tray 11 can always be suitably supported.

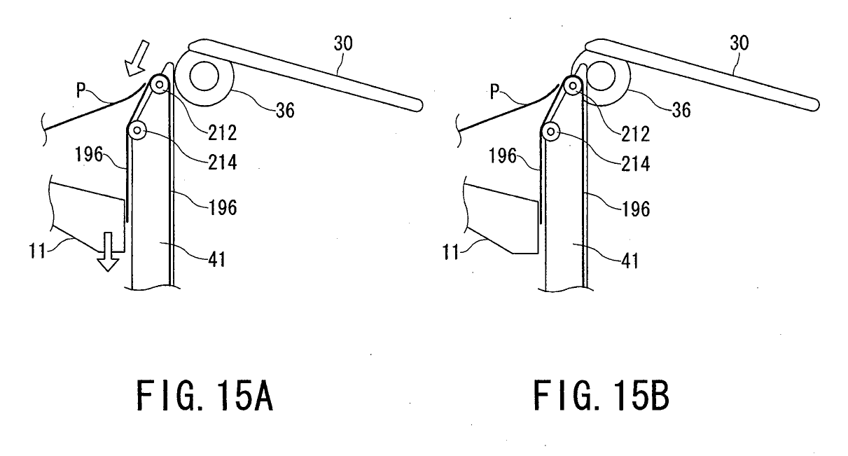

The support member 196 is wound to be inclined along the surface of the shutter 41 between the rollers 212 and 214. Accordingly, as shown in FIG. 15A, even when the trailing edge of the sheet P is stopped at the upper part of the shutter 41, the support member 196 travels in sync with the downward movement of the movable tray 11 as described above, and therefore, the sheet P is dropped to the movable tray 11. That is, the support member 196 urges the sheet P to be stacked on the movable tray 11. As a result, it is possible to prevent that the sheet stops on the inclined surface of the shutter 41 and prevents the stack of the subsequent sheet.

Incidentally, as shown in FIG. 15B, it is preferable that the outer periphery of the roller 212 of the support member unit 190 is arranged at a position where it overlaps with at least a part of the outer periphery of the conveyance roller 36 located at the front edge part of the processing tray 30 when seen in the direction along the rotation axis of the roller 212. By the arrangement as stated above, it is possible to prevent that the trailing edge of the discharged sheet remains in the gap between the conveyance roller 36 and the roller 212.

In the above description, although one end of the support member 196 is fixed to the movable tray 11, and the other end is fixed to the lateral frame member 222 of the movable tray 11, no limitation is made to this. For example, one end of the support member 196 is fixed to the movable tray 11, and a weight may be attached to the other end, or the other end is attached with an elastic member such as a spring and may be fixed to the body of the sheet finishing apparatus 1.

Besides, in the embodiment, although the description is made on the case where two belts are used as the support member 196, no limitation is made to this. For example, four belts may be used as the support member 196. In this case, for example, when the trailing edge of a sheet of a small size such as B5 size is supported, two belts at the inner side or two belts at one side are used, and when the trailing edge of a sheet of a large size such as A3 size is supported, the four belts are used.

Thus far, the sheet finishing apparatus which has the shutter 11 is described. However, the support member 196 may be applied to the sheet finishing apparatus which does not have the shutter 11. In this case, the support member 196 moves vertically only along the outer surface of the outer wall 50.

The sheet finishing apparatus 1 of this embodiment includes the support member unit 190 having the support member 196 which travels the same distance as the movement distance of the movable tray 11 in synchronization with the movement of the movable tray 11. Accordingly, the trailing edge of the sheet stacked on the movable tray 11 directly contacts the support member 196 which moves in the same direction and at the same speed as the movable tray 11, and does not scrape against the outer surface of the outer wall 50 or the outer surface of the shutter 41. As a result, it is possible to prevent that the trailing edges of a large number of sheets stacked on the movable tray 11 are vibrated and an abnormal sound is generated.

Further, as described above, the surface of the support member 196, which, contacts the sheet discharged from the discharge port, is the electrically grounded conductive surface. Thus, even if the discharged sheet is charged with static electricity, the static electricity of the sheet can be immediately removed by the contact between the sheet and the support member 196.

Thus, an attraction force due to the static electricity does not act between the trailing edge of the discharged sheet and the outer surface of the shutter 41 or the outer surface of the outer wall 50, and a so-called trailing edge remaining phenomenon can be suppressed.

Besides, a repelling force due to static electricity does not act between an already stacked sheet and a newly discharged sheet, and the newly discharged sheet is not floated by the repelling force and lateral sliding does not occur.

As stated above, in this embodiment, since the support member 196 has the electricity removing effect of the static electricity of the sheet, the alignment of the sheets stacked on the movable tray 11 is improved.

While certain embodiments have been described, these embodiments have been presented by way of example only, and are not intended to limit the scope of the invention. Indeed, the novel apparatuses and units described herein may be embodied in a variety of other forms; furthermore, various omissions, substitutions and changes in the form of the apparatuses and units described herein may be made without departing from the spirit of the invention. The accompanying claims and their equivalents are intended to cover such forms or modifications as would fall within the scope and spirit of the invention.

What is claimed is:

1. A sheet finishing apparatus comprising:
an outer wall having a discharge port of a sheet;
a movable tray that stacks the sheet discharged from the discharge port, moves vertically along the outer surface of the outer wall according to a stack amount of the sheet, and has a stacking surface inclined to cause a position of a trailing edge of a sheet to become lower than a position of a leading edge of the sheet; and
a support member that is provided at a position outside the outer surface of the outer wall, contacts the trailing edge of the sheet stacked on the movable tray to hold the sheet, and removes static electricity from the sheet.

2. The apparatus of claim 1, wherein the support member moves in a same direction and at a same speed as the movable tray.

3. The apparatus of claim 1, wherein the support member is a belt that moves in a same direction and at a same speed as the movable tray.

4. The apparatus of claim 3, wherein a surface of the belt, which contacts the sheet, has conductivity and the surface having the conductivity is electrically grounded.

5. The apparatus of claim 3, wherein a surface of the belt, which contacts the sheet, is made of a conductive plastic film, or the contact surface is covered with the conductive plastic film, and the conductive plastic film is electrically grounded.

6. The apparatus of claim 3, wherein a surface of the belt, which contacts the sheet, is made of a conductive nonwoven fabric, or the contact surface is covered with the conductive nonwoven fabric, and the conductive nonwoven fabric is electrically grounded.

7. The apparatus of claim 3, further comprising:
a shutter that is provided on a substantially same surface as an outer surface of the outer wall and moves vertically along the outer wall to open and close a part of the discharge port;
a first roller rotatably fixed to an upper part of the shutter; and
a second roller rotatably fixed to a lower part of the shutter, wherein
the belt is a non-circular belt extended between the first roller and the second roller, and at least one end of the non-circular belt is fixed to a sheet stacking surface side of the movable tray.

8. The apparatus of claim 7, further comprising a fixing member that is disposed at an opposite side to a side of the shutter facing the movable tray and moves together with the movable tray, wherein
the other end of the non-circular belt is fixed to the fixing member.

9. The apparatus of claim 7, wherein
the first roller is rotatably fixed to the upper part of the shutter at a position higher than a highest position in a movable range of the movable tray, and
the second roller is rotatably fixed to the lower part of the shutter at a position lower than a lowest position in the movable range of the movable tray.

10. The apparatus of claim 7, further comprising a conveyance roller that is provided in a vicinity of an exit of the discharge port and pushes out the sheet from the discharge port, wherein
the first roller is arranged at a position where an outer periphery of the first roller overlaps with at least a part of an outer periphery of the conveyance roller when seen from a direction along a rotation axis of the first roller.

11. An image forming apparatus, comprising:
a scanner to read a document;
a printer to print image data of the document read by the scanner to a sheet;
an outer wall having a discharge port for discharging the sheet printed by the printer;
a movable tray that stacks the sheet discharged from the discharge port, moves vertically along the outer surface of the outer wall according to a stack amount of the sheet, and has a stacking surface inclined to cause a position of a trailing edge of a sheet to become lower than a position of a leading edge of the sheet; and
a support member that is provided at a position outside the outer surface of the outer wall, contacts the trailing edge of the sheet stacked on the movable tray to hold the sheet, and removes static electricity from the sheet.

12. The apparatus of claim 11, wherein the support member moves in a same direction and at a same speed as the movable tray.

13. The apparatus of claim 11, wherein the support member is a belt that moves in a same direction and at a same speed as the movable tray.

14. The apparatus of claim 13, wherein a surface of the belt, which contacts the sheet, has conductivity and the surface having the conductivity is electrically grounded.

15. The apparatus of claim 13, wherein a surface of the belt, which contacts the sheet, is made of a conductive plastic film, or the contact surface is covered with the conductive plastic film, and the conductive plastic film is electrically grounded.

16. The apparatus of claim 13, wherein a surface of the belt, which contacts the sheet, is made of a conductive nonwoven fabric, or the contact surface is covered with the conductive nonwoven fabric, and the conductive nonwoven fabric is electrically grounded.

17. The apparatus of claim 13, further comprising:
a shutter that is provided on a substantially same surface as an outer surface of the outer wall and moves vertically along the outer wall to open and close a part of the discharge port;
a first roller rotatably fixed to an upper part of the shutter; and
a second roller rotatably fixed to a lower part of the shutter, wherein
the belt is a non-circular belt extended between the first roller and the second roller, and at least one end of the non-circular belt is fixed to a sheet stacking surface side of the movable tray.

18. The apparatus of claim 17, further comprising a fixing member that is disposed at an opposite side to a side of the shutter facing the movable tray and moves together with the movable tray, wherein
the other end of the non-circular belt is fixed to the fixing member.

19. The apparatus of claim 17, wherein
the first roller is rotatably fixed to the upper part of the shutter at a position higher than a highest position in a movable range of the movable tray, and
the second roller is rotatably fixed to the lower part of the shutter at a position lower than a lowest position in the movable range of the movable tray.

20. The apparatus of claim 17, further comprising a conveyance roller that is provided in a vicinity of an exit of the discharge port and pushes out the sheet from the discharge port, wherein
the first roller is arranged at a position where an outer periphery of the first roller overlaps with at least a part of an outer periphery of the conveyance roller when seen from a direction along a rotation axis of the first roller.
